(19) United States
(12) Patent Application Publication
(10) Pub. No.: US 2006/0261694 A1
(43) Pub. Date: Nov. 23, 2006

(54) Motor structure

(75) Inventors: Chien-Hsiung Huang, Taoyuan Hsien (TW); Lee-Long Chen, Taoyuan Hsien (TW); Shih-Ming Huang, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/411,964

(22) Filed: Apr. 27, 2006

(30) Foreign Application Priority Data
May 19, 2005 (TW) 094116207

(51) Int. Cl. H02K 7/09; H02K 7/00; H02K 11/00

(52) U.S. Cl. 310/90.5; 310/67 R

(57) ABSTRACT

A motor structure includes a stator, a bearing, a shaft, a magnetic fluid, a first magnetic ring, and a second magnetic ring. The stator has a containing space. The bearing has a axial hole and is disposed in the containing space. The shaft passes through the axial hole of the bearing. There is a gap formed between an inner wall of the axial hole and the shaft. The magnetic fluid is filled in the gap between the bearing and the shaft. The first magnetic ring is sleeved around the shaft. The second magnetic ring is disposed around the outside of the first magnetic ring. One side of the second magnetic ring connects to the stator body. There is a magnetic force between the first magnetic ring and the second magnetic ring.

### BACKGROUND OF THE INVENTION

1. Field of Invention

The invention relates to a motor structure for preventing oil leakage and, in particular, to a motor structure using a magnetic principle to prevent oil leakage.

2. Related Art

Most of modem apparatuses use motors for transmissions. Therefore, the quality of a motor plays an important role in an apparatus. If the motor is not stable, the operation of the whole apparatus will have some problems. In particular, the bearing is a key to the motor quality.

Earlier motors used the ball bearing. However, the ball bearing has a higher cost, so that some manufacturers have proposed the idea of using sleeve bearings. The usual sleeve bearing is made of copper. Its interior has many pores to hold the lubricant oil by the capillary force. Accordingly, when a shaft is relatively rotated in the sleeve bearing, the lubricant oil may work between the shaft and the sleeve bearing. Thus, the sleeve bearing has been widely used in small motors because its cost is lower than the ball bearing.

As shown in FIG. 1, a conventional sleeve bearing 1 includes a shaft 11, a base 12, a magnetic ring 13, a first bearing 14, a second bearing 15, a fixing element 16, and a magnetic oil 17. The shaft 11 is installed on the base 12. The magnetic ring 13 is disposed around the shaft 11. The first bearing 14 and the second bearing 15 are provided on both ends in the axial direction of the magnetic ring 13 and around the shaft 11. The fixing element 16 is installed between the second bearing 15 and the base 12 to fix the shaft 11. The magnetic oil 17 is filled in the gap among the shaft 11, the base 12, the first bearing 14, the magnetic ring 13, the second bearing 15, and the fixing element 16. The magnetic lines M1 generated by the magnetic ring 13 restrict the magnetic oil 17 inside the gap.

The positioning procedure for the motor bearing is very important. A tilting bearing will affect the stability of the running motor. Since the prior art utilizes two bearings, the positioning procedure is more difficult and the cost is thus higher. To prevent the magnetic oil 17 from leaking, an adhesive layer 18 is formed on the upper edge of the first bearing 14. This further increases the cost. Therefore, it is an important subject of the invention to provide a motor structure, such that the positioning of the bearings becomes easier, the cost becomes lower, and the oil is prevented from leaking.

### SUMMARY OF THE INVENTION

To achieve the foregoing, the invention is to provide a motor structure for preventing oil leakage that is easier in positioning.

To achieve the above, a motor structure for preventing oil leakage of the invention includes a stator, a bearing, a shaft, a magnetic fluid, a first magnetic ring, and a second magnetic ring. The stator has a containing space. The bearing has a axial hole and is disposed in the containing space. The shaft goes through the axial hole of the bearing. There is a gap formed between an inner wall of the axial hole and the shaft. The magnetic fluid is filled in the gap between the bearing and the shaft. The first magnetic ring is sleeved around the shaft. The second magnetic ring rings the outside of the first magnetic ring. One side of the second magnetic ring connects to the stator body. There is a magnetic force between the first magnetic ring and the second magnetic ring for constraining the magnetic fluid inside the gap between the bearing and the shaft.

In addition, to achieve the above, a motor structure for preventing oil leakage of the invention includes a stator, a bearing, a shaft, a magnetic fluid, and a magnetic ring. The stator has a containing space. The bearing has a axial hole and is disposed inside the containing space of the stator. The shaft goes through the axial hole of the bearing. There is a gap formed between an inner wall of the axial hole and the shaft. The magnetic fluid is filled in the gap between the bearing and the shaft. The magnetic ring rings the outside of the bearing. The two ends in the axial direction of the magnetic ring are the N and S poles.

As described above, the motor structure for preventing oil leakage of the invention uses the attractive magnetic force generated by the first and second magnetic rings to constrain the magnetic fluid inside the gap between the shaft and the bearing. In another aspect, the magnetic ring rings the outside of the bearing. In this case, the magnetic force covers a larger range, so that that magnetic fluid is restricted between the shaft and the bearing. In comparison with the prior art, the invention only requires a bearing, making the positioning procedure much easier. The disposition of the magnetic ring more easily constrains the magnetic fluid between the bearing and the shaft.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional sleeve bearing;

FIG. 2 is a schematic cross-sectional view of a motor structure according to a first embodiment of the invention;

FIG. 3 is another schematic cross-sectional view of the motor structure according to the first embodiment of the invention;

FIG. 4 is a schematic cross-sectional view of the motor structure according to a second embodiment of the invention;

FIG. 5 is another schematic cross-sectional view of the motor structure according to the second embodiment of the invention; and

FIG. 6 is a schematic cross-sectional view of another motor structure according to the second embodiment of the invention.

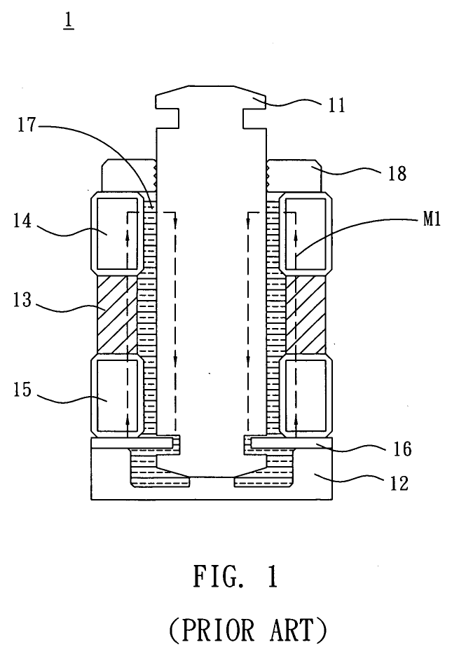

### DETAILED DESCRIPTION OF THE INVENTION

The present invention will be apparent from the following detailed description, which proceeds with reference to the accompanying drawings, wherein the same references relate to the same elements.

### FIRST EMBODIMENT

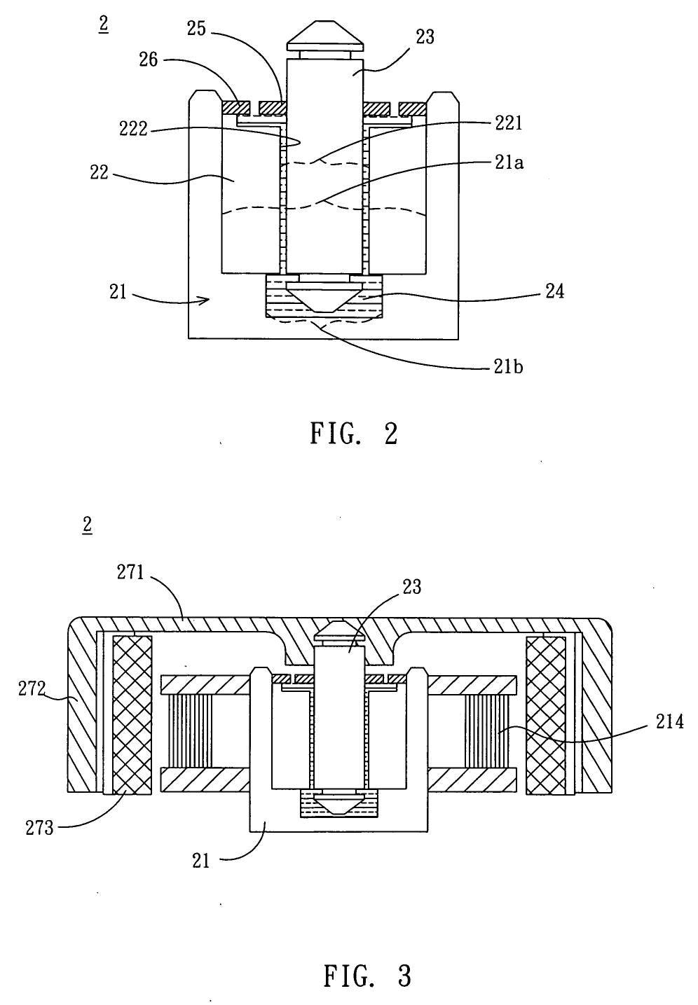

With reference to FIG. 2, a motor structure 2 according to a first embodiment of the invention includes a stator 21, a bearing 22, a shaft 23, a magnetic fluid 24, a first magnetic ring 25, and a second magnetic ring 26.

The stator 21 has a containing space 21a. In this embodiment, the stator 21 have a concave 21b, which is a hollow pillar with a closed bottom.

The bearing 22 has a axial hole 221 and is disposed inside the containing space 21a of the stator 21.

The shaft 23 passes through the axial hole 221 of the bearing 22. There is a gap formed between an inner wall 222 of the axial hole and the shaft 23. In this embodiment, the shaft 23 is disposed inside the concave 21b of the stator 21.

The magnetic fluid 24 is filled in the gap between the bearing 22 and the shaft 23. In this embodiment, the magnetic fluid 24 is a magnetic lubricant or obtained by adding magnetic powder into an oil. Moreover, the magnetic fluid 24 is filled in the concave 21b of the stator 21. The concave 21b holds the magnetic fluid 24 for replenishing the gap between the shaft 23 and the bearing 22. Therefore, the shaft 23 is lubricated at all times as it rotates in the bearing 22.

The first magnetic ring 25 is sleeved around and in contact with the shaft 23. The second magnetic ring 26 is disposed around the outside of the first magnetic ring 25. Preferably, one side of the second magnetic ring 26 connects to the stator 21 or the bearing 22. That is, the first magnetic ring 25 is fixed onto the shaft 23 and the second magnetic ring 26 in mounted onto the stator 21 or to the bearing 22. The first magnetic ring 25 and the second magnetic ring 26 are disposed in pair to produce a magnetic force. The magnetic force is an attractive force or repulsive force. In this embodiment, the magnetic fluid 24 is restricted within the gap between the bearing 22 and the shaft 23 by the attractive magnetic force of the first magnetic ring 25 and the second magnetic ring 26. The magnetic fluid 24 is thus prevented from leaking out.

With reference to FIG. 3, the motor structure 2 according to the first embodiment of the invention may further includes a rotor 27. The rotor 27 has a rotor body 271 and a sidewall 272. The stator 21 further includes a coil 214.

In this embodiment, the center of the rotor body 271 connects to the shaft 23. The rotor 27 includes a magnetic element 273, which is installed on the sidewall 272 of the rotor 27. The magnetic element 273 is disposed opposite to the coil 214. When a current flow through the coil 214, the magnetic field is thus produced and makes the rotor 27 to rotate about the shaft 23. Therefore, the above disclosed structure for preventing oil leakage can provide desired lubrication effects.

### SECOND EMBODIMENT

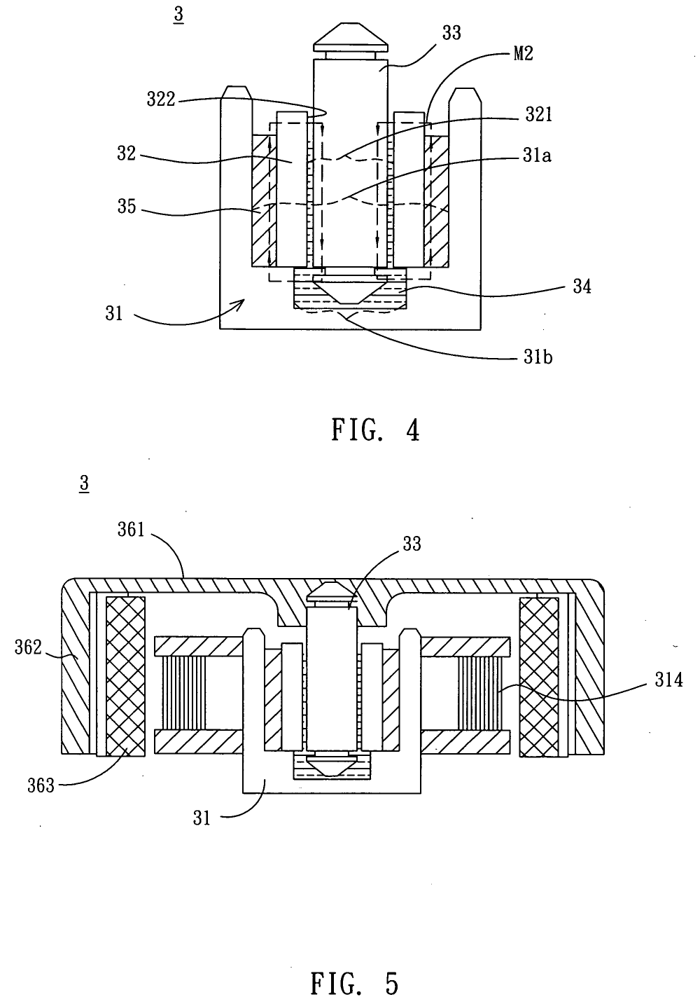

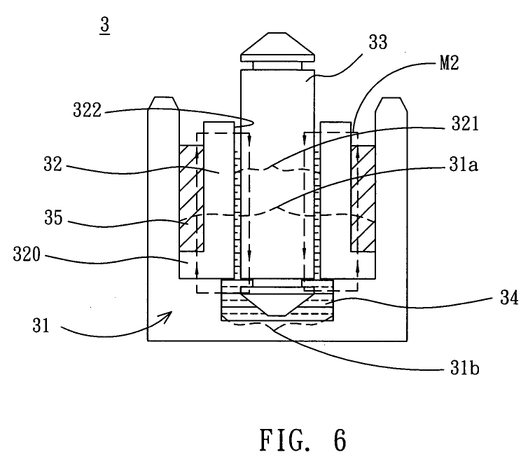

Referring to FIG. 4, the motor structure 3 according to the second embodiment of the invention includes a stator 31, a bearing 32, a shaft 33, a magnetic fluid 34, and a magnetic ring 35.

The stator 31 has a containing space 31a and a concave 31b. The bearing 32 has a axial hole 321. The shaft 33 passes through the axial hole 321 of the bearing 32. There is a gap between an inner wall of the axial hole 321 and the shaft 33. In this embodiment, the structures and functions of the stator 31, the containing space 31a, the concave 31b, the bearing 32, the axial hole 321, the shaft 33, and the magnetic fluid 34 are the same as those introduced in the first embodiment, so the detailed descriptions are omitted for concise purpose.

The magnetic ring 35 is disposed around the outside of the bearing 32. The two ends in the axial direction of the magnetic ring 35 are the N and S poles respectively. The magnetic ring 35 provides a magnetic force, as indicated by the magnetic lines M2 in FIG. 4. The magnetic fluid 34 is constrained by the magnetic field produced by the magnetic ring 35 to stay in the gap between the bearing 32 and the shaft 33. Thus, the magnetic fluid 34 does not leak out as the shaft rotates.

As shown in FIG. 5, the motor structure 3 according to the second embodiment of the invention may further include a rotor 36 having a rotor body 361, a sidewall 362, and a magnetic element 363. The stator 31 further includes a coil 314. In this embodiment, the structures and functions of the rotor body 361 of the rotor 36, the sidewall 362, the magnetic element 363, and the coil 314 of the stator 31 are the same as those in the first embodiment, so the detailed descriptions are omitted for concise purpose.

Besides, the bearing 32 in the motor structure 3 may further include a bottom ring portion 320. It is preferred to be formed together with the bearing 32. When the magnetic ring 35 is disposed around the outside of the bearing 32, the bottom ring portion 320 is in contact with a bottom side of the magnetic ring 35. Therefore, the magnetic ring 35 and the bearing 32 can be connected first before assembling. They are disposed together in the containing space 31a at the same time. This can reduce the difficulty in the assembly of the motor structure 3.

In summary, the motor structure 2 or 3 only use one set of bearing 22 or 32. In comparison with the prior art, the positioning procedure of the bearing is simpler as the related components are reduced. In addition, using the attractive first and second magnetic rings 25, 26 or, in another embodiment, by disposing the magnetic ring 35 around the outside of the bearing 32, the magnetic fluid is more effectively prevented from leaking. Therefore, the invention has its novelty and many advantages over the prior art in oil leakage prevention. In comparison with the prior art, the invention only requires a bearing, making the positioning procedure much easier. The disposition of the magnetic ring more easily constrains the magnetic fluid 24 or 34 between the bearing 22 or 32 and the shaft 23 or 33.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor structure comprising:
a stator having a containing space;
a bearing having an axial hole and disposed inside the containing space of the stator,
a shaft passing through the axial hole of the bearing, wherein a gap is formed between an inner wall of the axial hole and the shaft;
a magnetic fluid filled in the gap between the bearing and the shaft;
a first magnetic ring sleeved around the shaft; and
a second magnetic ring disposed corresponding to the first magnetic ring so as to generate a magnetic force with the first magnetic ring.

2. The motor structure of claim 1, wherein the stator further comprises a concave filled with the magnetic fluid.

3. The motor structure of claim 2, wherein the concave is a hollow pillar with a closed bottom.

4. The motor structure of claim 1, wherein the first magnetic ring is fixed onto the shaft and the second magnetic ring in mounted onto the bearing or the stator.

5. The motor structure of claim 1, wherein the magnetic fluid is a magnetic lubricant.

6. The motor structure of claim 1, wherein the magnetic fluid is obtained by adding magnetic powder to an oil.

7. The motor structure of claim 1, wherein the magnetic fluid is restricted within the gap between the bearing and the shaft by an attractive or a repulsive magnetic force between the first magnetic ring and the second magnetic ring.

8. The motor structure of claim 1 further comprising:
a rotor having a rotor body and a sidewall, wherein the shaft is connected near the center of the rotor body.

9. The motor structure of claim 8, wherein the rotor further comprises a magnetic element installed on the sidewall to interact with a coil of the stator to produce a magnetic field.

10. A motor structure comprising:
a stator having a containing space;
a bearing having an axial hole and disposed inside the containing space of the stator,
a shaft passing through the axial hole of the bearing, wherein a gap is formed between an inner wall of the axial hole and the shaft;
a magnetic fluid filled in the gap between the bearing and the shaft; and
a magnetic ring telescoped around the bearing.

11. The motor structure of claim 10, wherein the stator further comprises a concave filled with the magnetic fluid.

12. The motor structure of claim 11, wherein the concave is a hollow pillar with a closed bottom.

13. The motor structure of claim 10, wherein two ends in an axial direction of the magnetic ring are an N pole and an S pole, respectively, for providing a magnetic force to restrict the magnetic fluid in the gap between the bearing and the shaft.

14. The motor structure of claim 10, wherein the magnetic fluid is a magnetic lubricant.

15. The motor structure of claim 10, wherein the magnetic fluid is obtained by adding magnetic powder to an oil.

16. The motor structure of claim 10, further comprising:
a rotor having a rotor body and a sidewall, wherein the shaft is connected near the center of the rotor body.

17. The motor structure of claim 16, wherein the rotor further comprises a magnetic element installed on the sidewall to interact with a coil of the stator to produce a magnetic field.

18. The motor structure of claim 10, wherein the bearing comprises a bottom ring portion, which is in contact with one side of the magnetic ring when the magnetic ring disposed around the outside of the bearing.
